(19) United States
(12) Patent Application Publication
(10) Pub. No.: US 2018/0116440 A1
(43) Pub. Date: May 3, 2018

(54) EGG COOKING DEVICE

(71) Applicant: Alex Kilicarslan, Irvine, CA (US)

(72) Inventor: Alex Kilicarslan, Irvine, CA (US)

(21) Appl. No.: 15/853,418

(22) Filed: Dec. 22, 2017

Related U.S. Application Data
(60) Provisional application No. 62/438,965, filed on Dec. 23, 2016.

(51) Int. Cl. A47J 29/06; A47J 43/14

(52) U.S. Cl. CPC A47J 29/06; B65D 85/32; A47J 43/14

(57) ABSTRACT

An egg cooking device, having an egg mold having: a lower portion having: a first tray having a first top surface and a first bottom surface; a lower bowl extending downwards from the first bottom surface and having a rim located at the first top surface; lower ridges along the rim; and an upper portion having: a second tray having a second top surface and a second bottom surface; upper ridges on the second bottom surface and being configured to be associated with the set of lower ridges; wherein the lower portion is sealed with the upper portion when the lower ridges are associated with the upper ridges; and wherein the lower portion and the upper portion sealed together form the egg mold defining a hollow inner space configured to receive and cook a food item created in a shape defined by the hollow inner space.

### CROSS-REFERENCE TO RELATED APPLICATIONS

This application claims the benefit of U.S. Provisional Application No. 62/438,965, filed Dec. 23, 2016, and Chinese Application No. 201730411416.7, filed Sep. 1, 2017, which are hereby incorporated by reference, to the extent that they are not conflicting with the present application.

### BACKGROUND OF INVENTION

### 1. Field of the Invention

The invention relates generally to cookware and more specifically to cookware for cooking or boiling eggs.

### 2. Description of the Related Art

Hard-boiling an egg must generally be performed with the egg intact, and this results in an inability to separate the yolk and egg whites prior to boiling. This can cause food waste should the user desire to cook the yolk and egg whites in a separate manner or use the yolk and whites differently. The hard-boiled egg must also be peeled after boiling, which is a messy and time-consuming process. The prior art includes products to allow a user to hard-boil an egg, but may be difficult to assemble, include many pieces per egg, require oil or other non-stick agents, may not be leak-proof. Some products may allow for cooking an egg, but not in an egg shape. Separated egg whites provided to a user may also be difficult to cook into a hard-boiled form. Therefore, there is a need for an easy to assemble and use device solves these problems, that allows a user to boil a cracked egg in an egg shape, such that the yolk and egg white may be separated prior to boiling.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect a flexible, food-safe egg cooking bag is provided that retains an egg shape, in which a cracked egg can be poured. The bag may be sealed for cooking the egg within. Thus, an advantage is an easily sealed bag can allow a user to boil a cracked, shell-less egg.

In another aspect a food-safe egg cooking tray is provided that has a plurality of egg-shaped portions, each for receiving an egg. Thus, an advantage is that a plurality of eggs may be cooked at once, each one shell-less and boiled into the shape of an egg. Another advantage is that time and space may be saved by using an egg cooking tray.

In another aspect, an egg cooking device having at least an egg mold is provided, the at least an egg mold comprising: a lower portion having: a first flat tray having a first top surface and a first bottom surface; a lower bowl extending downwards from the first bottom surface, the lower bowl having a first rim located at the first top surface; a set of lower tray ridges along the first rim; a flat base associated with the bottom lower bowl end; an upper portion having: a second flat tray having a second top surface and a second bottom surface; an upper bowl extending upwards from the second top surface, the upper bowl having a second rim located at the second bottom surface; a set of upper tray ridges along the second rim, the set of upper tray ridges being configured to be associated with the set of lower tray ridges; an access hole at a top end of the upper bowl, the access hole having an access hole rim; a set of access hole ridges along the access hole rim; a cap having: a top cap end; a bottom cap end having a cap rim; at least an air vent; a handle extending upwards from the top cap end; a set of cap ridges along the cap rim configured to be associated with the set of access hole ridges; wherein the lower portion is sealed with the upper portion when the set of lower tray ridges is associated with the set of upper tray ridges, and the upper portion is sealed with the cap when the set of access hole ridges is associated with the set of cap ridges; and wherein the lower portion, the upper portion, and the cap sealed together form the at least an egg mold defining a hollow inner space configured to receive and cook a food item by heating the food item; such that a cooked food item is created in a shape defined by the hollow inner space. An advantage may be that a user can easily separate egg whites from the egg yolk in order to hard-boil an egg, and may cook several eggs at once without the egg shell. Another advantage may be that the user can hard-boil egg whites provided in a carton or other similar packaging, into the shape of an egg. Another advantage may be that a user is able to combine various food items into the egg cooking device for boiling or cooking.

In another aspect, an egg cooking device having at least an egg mold is provided, the at least an egg mold comprising: a lower portion having: a first flat tray having a first top surface and a first bottom surface; a lower bowl extending downwards from the first bottom surface, the lower bowl having a first rim located at the first top surface; a set of lower tray ridges along the first rim; and an upper portion having: a second flat tray having a second top surface and a second bottom surface; a set of upper tray ridges on the second bottom surface, the set of upper tray ridges being configured to be associated with the set of lower tray ridges; wherein the lower portion is sealed with the upper portion when the set of lower tray ridges is associated with the set of upper tray ridges; and wherein the lower portion and the upper portion sealed together form the at least an egg mold defining a hollow inner space configured to receive and cook a food item by heating the food item; such that a cooked food item is created in a shape defined by the hollow inner space. Again, an advantage may be that a user can easily separate egg whites from the egg yolk in order to hard-boil an egg, and may cook several eggs at once without the egg shell. Another advantage may be that the user can hard-boil egg whites provided in a carton or other similar packaging, into the shape of an egg. Another advantage may be that a user is able to combine various food items into the egg cooking device for boiling or cooking.

In another aspect, a method of cooking at least a portion of an egg using an egg cooking device is provided, having at least an egg mold, the at least an egg mold comprising: a lower portion having: a first flat tray having a first top surface and a first bottom surface; a lower bowl extending downwards from the first bottom surface, the lower bowl having a first rim located at the first top surface; a set of lower tray ridges along the first rim; a flat base associated with the bottom lower bowl end; an upper portion having: a second flat tray having a second top surface and a second bottom surface; an upper bowl extending upwards from the second top surface, the upper bowl having a second rim located at the second bottom surface; a set of upper tray ridges along the second rim, the set of upper tray ridges being configured to be associated with the set of lower tray ridges; an access hole at a top end of the upper bowl, the access hole having an access hole rim; a set of access hole ridges along the access hole rim; a cap having: a top cap end; a bottom cap end having a cap rim; at least an air vent; a handle extending upwards from the top cap end; a set of cap ridges along the cap rim configured to be associated with the set of access hole ridges; wherein the lower portion is sealed with the upper portion when the set of lower tray ridges is associated with the set of upper tray ridges, and the upper portion is sealed with the cap when the set of access hole ridges is associated with the set of cap ridges; and wherein the lower portion, the upper portion, and the cap sealed together form the at least an egg mold defining a hollow inner space configured to receive and cook the at least the portion of the egg by a heating means, such that a cooked egg item is created in a shape defined by the hollow inner space; the method comprising the steps of: providing the lower portion, the upper portion, and the cap of the egg cooking device in a separated state; aligning the upper bowl with the lower bowl by aligning the set of upper tray ridges with set of lower tray ridges; applying a force to the upper portion; sealing the upper portion to the lower portion; cracking the egg; pouring at least a portion of the egg into the access hole; aligning the cap with the access hole by aligning the set of cap ridges with the set of access hole ridges; applying a force to the cap; sealing the cap to the access hole of the upper portion; placing the egg cooking device into a heating means; leaving the egg cooking device in the heating means for a predetermined amount of time such that the at least a portion of the egg is cooked to create the cooked egg item; removing the egg cooking device from the heating means; separating the upper portion from the lower portion; and removing cooked egg item from the lower portion. Again, an advantage may be that a user can easily separate egg whites from the egg yolk in order to hard-boil an egg, and may cook several eggs at once without the egg shell. Another advantage may be that the user can hard-boil egg whites provided in a carton or other similar packaging, into the shape of an egg. Another advantage may be that a user is able to combine various food items into the egg cooking device for boiling or cooking.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates the front perspective view of an egg cooking device in a bag form, in a closed state, according to an aspect.

FIG. 2 illustrates the front perspective view of an egg cooking device in a bag form, in an open state, according to an aspect.

FIG. 3 illustrates the right side elevation view of the closed state of FIG. 1, the left side being similar, according to an aspect.

FIG. 4 illustrates the detailed view of the zipper portion of the egg cooking device in a bag form as shown in FIG. 3, according to an aspect.

FIG. 5 illustrates the front plan view of the closed state of FIG. 1, according to an aspect.

FIG. 6 illustrates the top perspective view of an egg cooking device in a tray with lid form, in an open state, according to an aspect.

FIG. 7 illustrates the top plan view of an egg cooking device in a tray with lid form, in an open state, according to an aspect.

FIG. 8 illustrates the detailed side perspective view of an egg receiving portion of the tray of FIG. 6, according to an aspect.

FIG. 9 illustrates the side sectional view of an egg cooking device of FIG. 6, in a closed state, according to an aspect.

FIG. 10 illustrates the top perspective view of another example of an egg cooking device in a tray with lid form, according to an aspect.

FIG. 11 illustrates the top perspective view of another example of an egg cooking device in a rectangular tray with lid form, according to an aspect.

FIG. 12 illustrates the side perspective view of another example of an egg cooking device having a full egg mold (“egg cooking device,” “full mold egg cooking device,” or “egg cooking tray”) 1203-b in a closed state, according to an aspect.

FIG. 13 illustrates the exploded perspective view of the egg cooking device of FIG. 12, according to an aspect.

FIG. 14 illustrates the bottom perspective view of the upper portion of the egg cooking device of FIG. 12, according to an aspect.

FIG. 15 illustrates the side sectional elevation view of the egg cooking device of FIG. 12 in a closed state, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

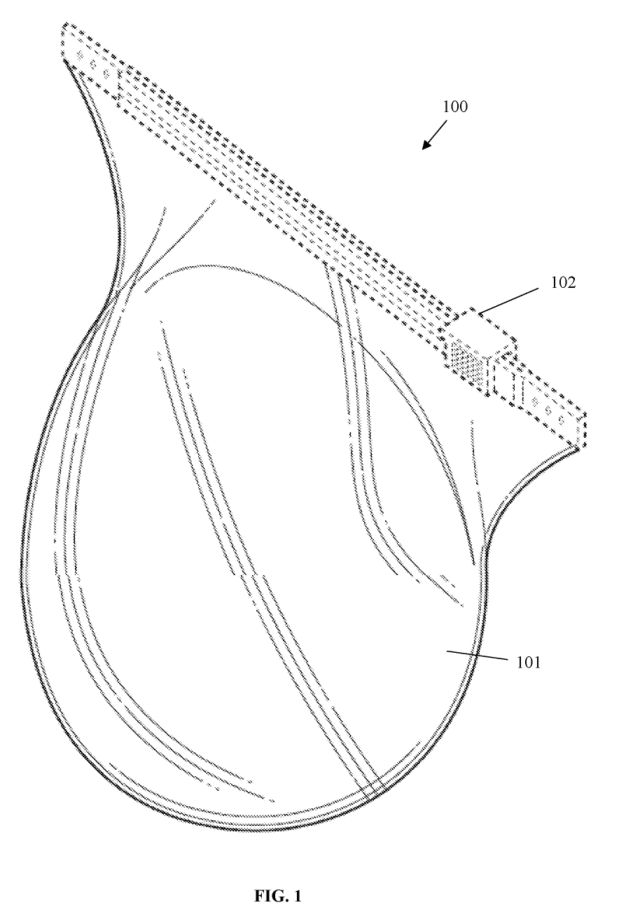

FIG. 1 illustrates the front perspective view of an egg cooking device in a bag form 100 (“egg cooking device in a bag form,” “egg cooking bag,” or “bag”), in a closed state, according to an aspect. An egg cooking device may, for example, be provided with an egg mold in the shape of a hard-boiled egg, such that an egg may be boiled without its shell and retain an egg shape. The egg cooking device may be provided in a bag form, as an example as shown. The egg cooking bag 100 may be constructed from any suitable food-safe, flexible material, such as, for example, food-safe silicone or plastic, which may allow for non-stick cooking without the need for any other non-stick agents such as oil. The material of the egg cooking bag 100 may be transparent, such that a user may be able to see the egg and whether it has become hard-boiled. The egg cooking bag 100 may be enclosed using, for example, a zipper 102, at the top of the egg cooking bag. Thus, the bag 100 may be completely submerged in boiling water to cook a shell-less egg. The egg cooking bag 100 may also be provided in a non-reusable form, which may be more convenient for a user, by eliminating the need to clean the device.

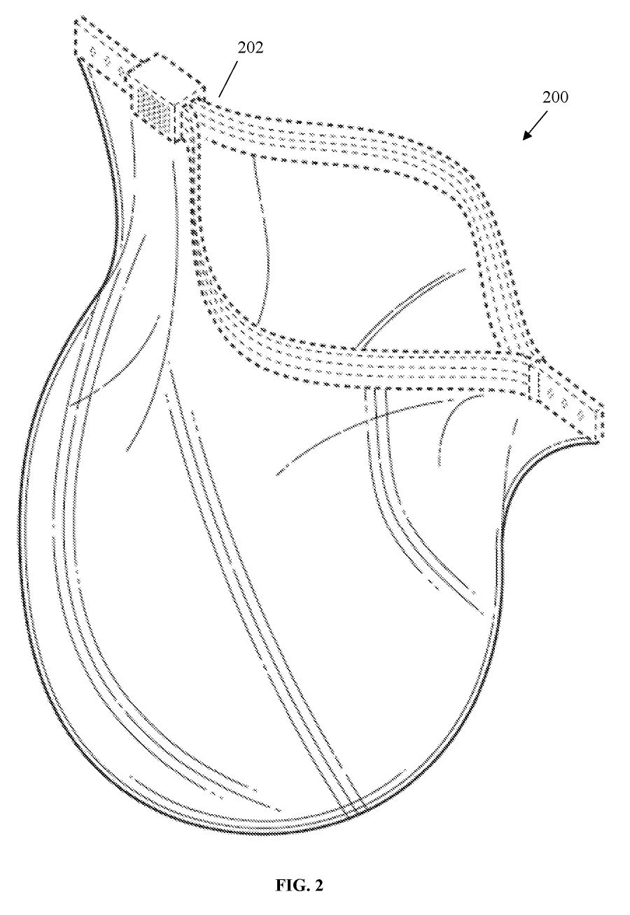

FIG. 2 illustrates the front perspective view of an egg cooking device in a bag form 200, in an open state, according to an aspect. The egg cooking bag 200 may be provided in the shape of a hard-boiled egg, and may be flexible, such that a cracked egg may be poured into the egg and easily removed once boiled. The egg cooking bag 200 may be opened and closed, and may be reusable, by a zipper 202, or any other suitable means.

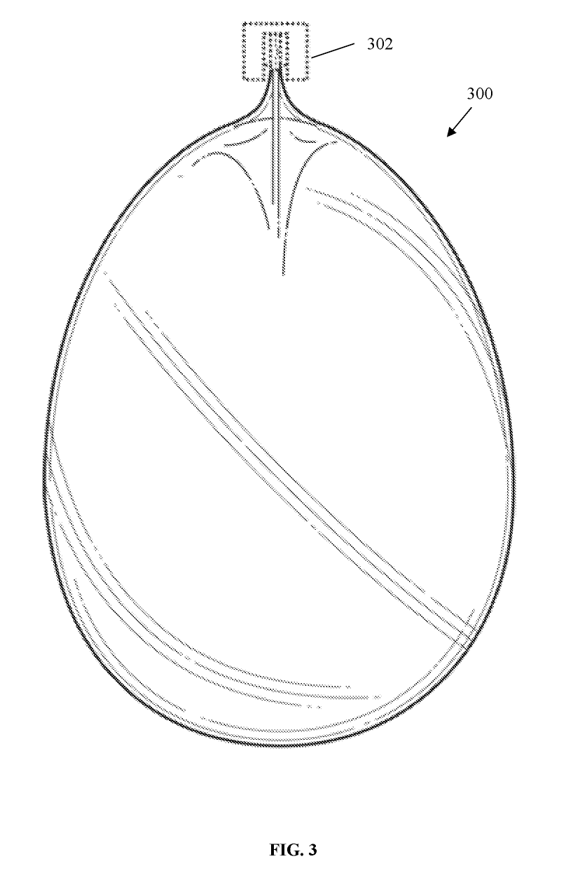

FIG. 3 illustrates the right side elevation view of the closed state of the egg cooking bag of FIG. 1, the left side being similar, according to an aspect. The egg cooking bag 300 may be flexible, yet firm enough to maintain an egg shape, and, again, may be securely closed using a zipper 302.

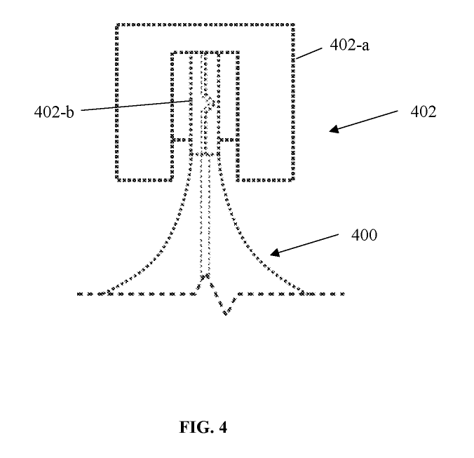

FIG. 4 illustrates the detailed view of the zipper portion 402 of the egg cooking device in a bag form as shown in FIG. 3, according to an aspect. As an example, the zipper 402 may be opened and closed by sliding a zipper head 402-a, which may pull apart or seal together a locking zipper portion 402-b. Thus, an advantage may by the user may easily and quickly open and close the egg cooking bag 400.

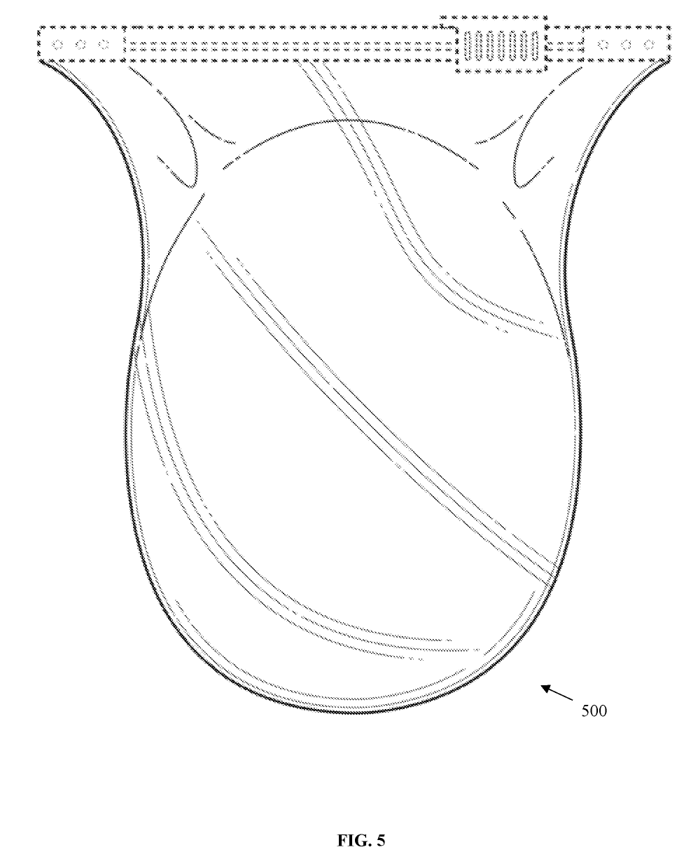

FIG. 5 illustrates the front plan view of the closed state of the egg cooking bag of FIG. 1, according to an aspect. Again, the egg cooking bag 500 may be flexible, yet firm enough to maintain an egg shape.

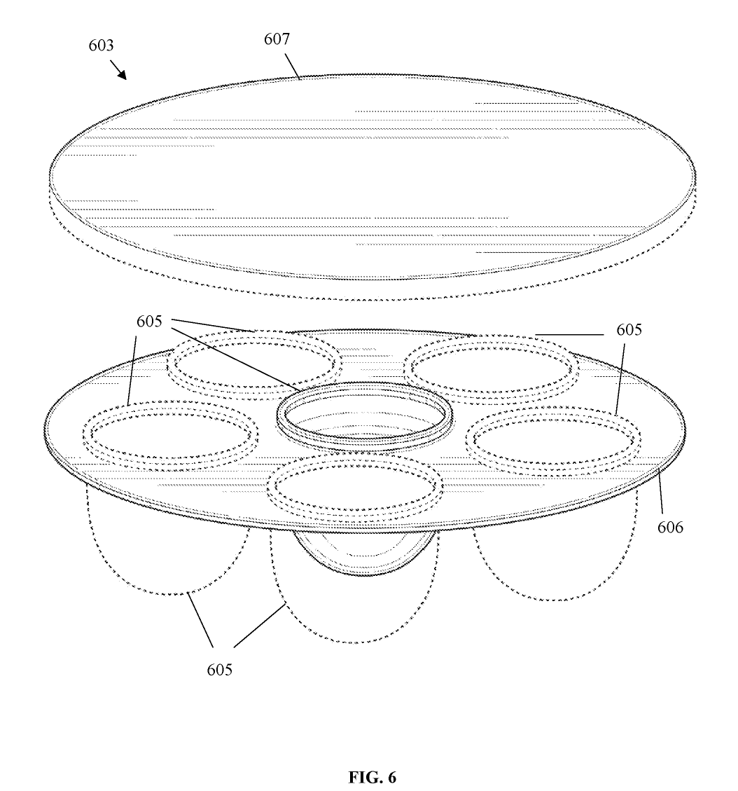

FIG. 6 illustrates the top perspective view of an egg cooking device in a tray with lid form 603, having a partial egg mold (“egg cooking device in a tray with lid form,” “egg cooking tray,” “egg cooking tray with lid,” “partial mold egg cooking device,” or “tray with lid”), in an open state, according to an aspect. An egg cooking tray 603 may be provided with one or more egg molds. The egg cooking tray 603 may be provided with a plurality of lower egg-receiving portions or bowls 605, each portion or lower bowl 605 having the partial shape of a hard-boiled egg, such that an egg may be boiled without its shell and retain at least a partial egg shape. The lower egg-receiving portion 605 of the egg cooking device may be in the shape of half an egg, as an example. An egg cooking tray 603 may be provided having a plurality of lower egg-receiving portions in a lower tray (“lower tray,” “bottom tray,” or “lower portion”) 606, and may, for example, have six lower egg-receiving portions 605. The bottom tray 606 may be round as shown, and may be in a circle or oval shape. The bottom tray 606 may be closed and covered with a lid (“lid,” “upper portion,” or “upper tray”) 607. Thus, when an egg is cracked and poured into a lower egg-receiving portion 605, the egg may be boiled by placing the covered tray with lid 603 into, for example, boiling water. An egg cooking tray 603 may be provided with a flat lid 607, wherein the lower egg-receiving portions 605 may have the shape of a half or partial egg, but may be sized to accommodate a whole shell-less egg. The egg cooking tray 603 may be constructed from any suitable food-safe material, such as, for example, silicone or plastic, and may be flexible such that the lower egg-receiving portions 605 may be pushed upwards to release or force out the cooked egg easily.

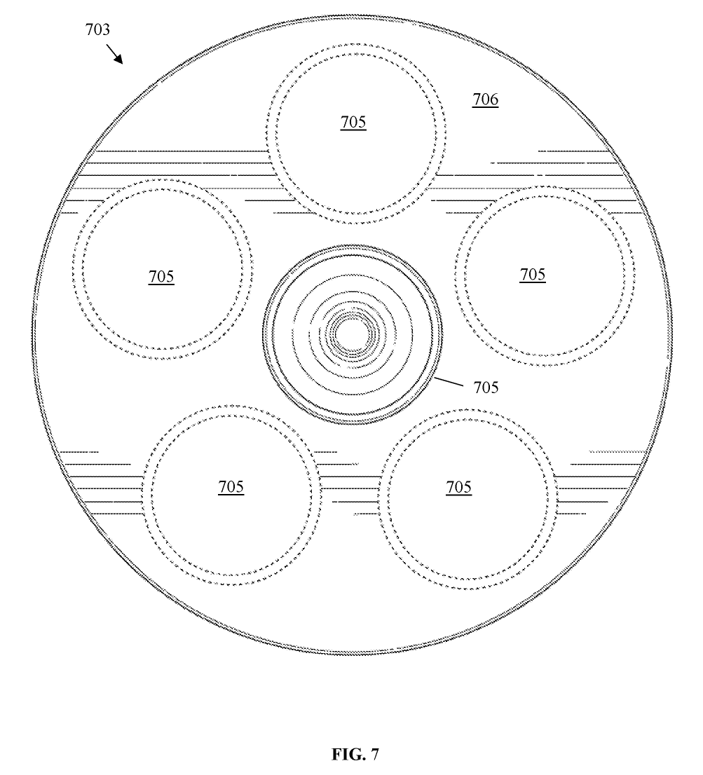

FIG. 7 illustrates the top plan view of an egg cooking device in a tray with lid form 703 (lid not shown), in an open state, according to an aspect. As an example, the lower tray 706 may contain six lower egg-receiving portions 705, which may be arranged evenly within the lower tray 706.

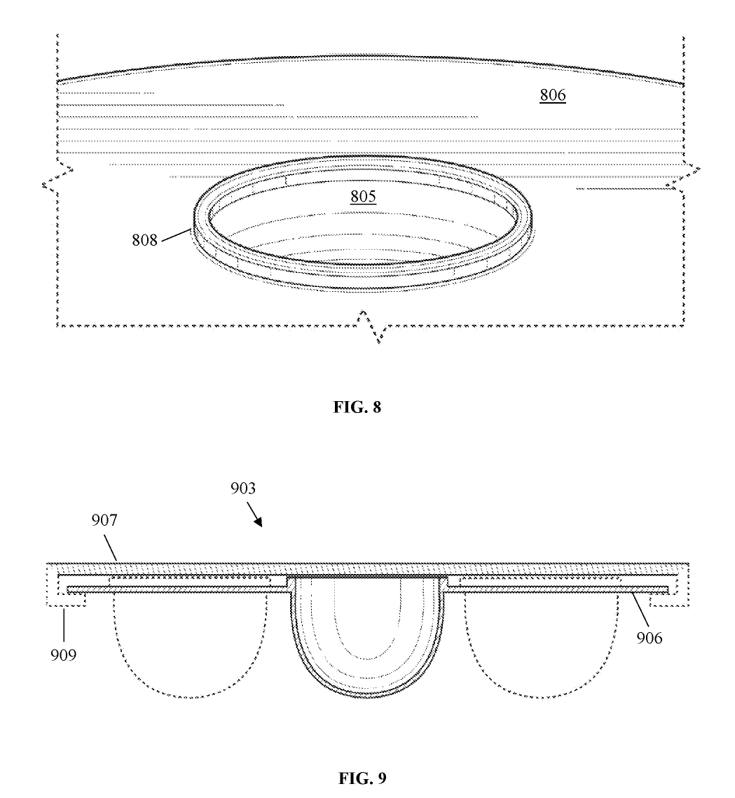

FIG. 8 illustrates the detailed side perspective view of a lower egg receiving portion 805 of the egg cooking tray 806 of FIG. 6, according to an aspect. Each lower egg receiving portion 805 may include a small rim or raised edge 808, which may help to prevent leaks or spills when a user pours in a cracked egg. The rim 808 may also help prevent leaks or spills when the tray 806 is handled before a lid is secured to the lower tray. The rim 808 may also correspond or match a portion of the lid such that the lid is able to snugly secure to the lower portion 806.

FIG. 9 illustrates the side sectional view of an egg cooking tray 903 of FIG. 6, in a closed state, according to an aspect. The egg cooking tray 903 may be secured or sealed for cooking eggs by covering the lower tray 906 with a lid 907. The lid 907 may be secured to the lower tray 906 by any suitable means, such as, for example, snapping an end clip portion 909 around the edge of the lower tray 906. Each lower egg-receiving portion 905 may thus be covered such that the shell-less eggs within may be held in a half-egg shape or a partial egg shape.

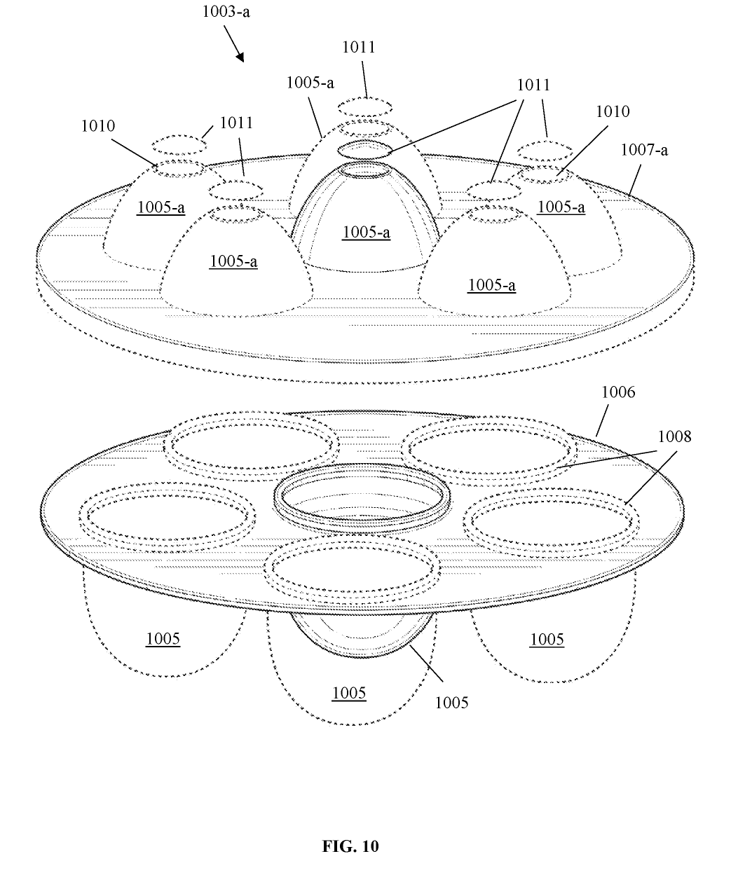

FIG. 10 illustrates the top perspective view of another example of an egg cooking device in a tray with lid form 1003-a, having full egg molds, according to an aspect. An egg cooking tray (“full mold egg cooking tray,” “full mold egg cooking device,” “whole egg cooking tray,” or “whole egg cooking device”) 1003-a may be provided with at least one egg mold within which cracked eggs can be cooked. Each egg mold may be formed by a lower tray 1006 having lower egg-receiving portions 1005, and a lid 1007-a having upper egg-receiving portions or upper bowls 1005-a, and a single egg cooking device 1003-a may have one or more egg molds. Each upper egg-receiving portion 1005-a may be substantially bowl-shaped, and extending upwards from the lid 1007-a. The egg cooking device 1003-a may be used to cook a plurality of shell-less eggs at once, and may be used by first fitting the lid 1007-a onto the lower tray 1006. A cracked egg or provided egg whites may be poured into the top access hole (“top access hole,” “access hole,” “access opening,” “top opening,” or “top hole”) 1010 of each upper egg-receiving portion 1005-a, such that the egg white and yolk or separated egg white or separated yolk fills both the lower egg-receiving portion 1005 and the upper egg-receiving portion 1005-a. The lower egg-receiving portions 1005 may be shaped and sized to fit half of an egg, such that when paired with a lid 1007-a having lower egg-receiving top portions 1005-a, the full mold egg cooking device 1003-a may boil shell-less eggs into an egg shape. After pouring a cracked egg into each top hole or opening 1010, the opening may be sealed or plugged with a cap 1011. The cap 1011 may be free as shown and plugged into the top opening 1010, or may be attached to the lower egg-receiving top portions 1005-a by any suitable means, such as, for example, by a connecting strip. Again, the lower egg-receiving portions 1005 may include rims 1008, or may be provided without rims.

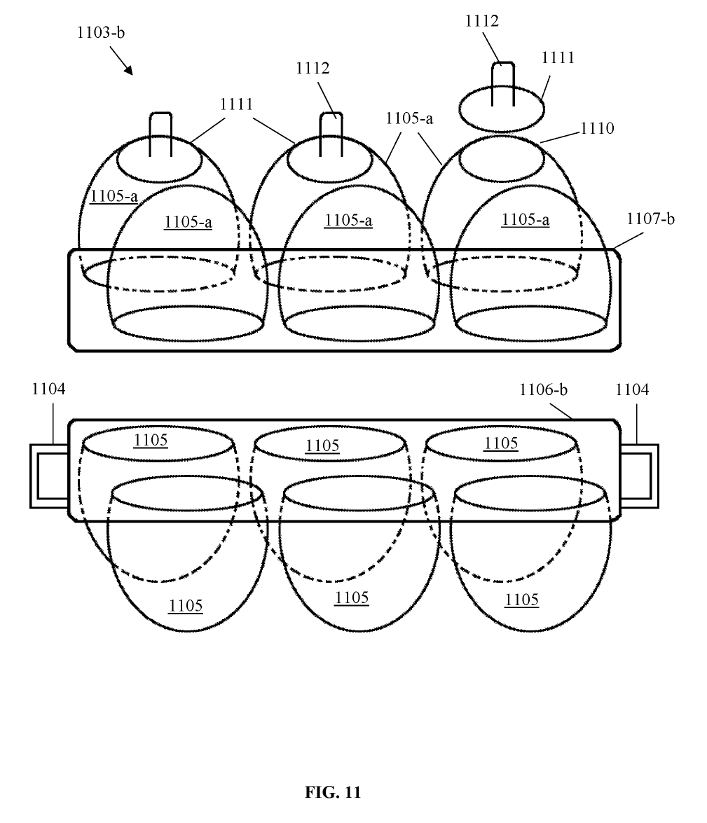

FIG. 11 illustrates the top perspective view of another example of an egg cooking device in a rectangular tray with lid form 1103-b (“rectangular egg cooking device,” “egg cooking tray,” “egg cooking device,” or “rectangular egg cooking tray”), according to an aspect. A rectangular lower tray (“lower tray,” or “lower portion”) 1106-b may be provided having lower egg-receiving portions 1105. A rectangular tray 1106-b may be provided with a flat lid (as shown in FIG. 6) or with a rectangular lid 1107-b having upper egg-receiving top portions 1105-a such that a full egg shaped mold is provided when the lid 1107-b is connected together or combined with the lower portion 1106-b also having lower egg-receiving portions 1105.

Each upper egg-receiving portion 1105-a may have a top opening 1110 (shown only in the rear egg-receiving portions for clarity). Each top opening 1110 may be sealed with a cap 1111, which may include a cap grip or cap handle 1112, for the user to easily grasp the cap 1111. The user may thus use the cap handle 1112 for plugging the cap 1111 into the top opening 1110 or removal of the cap 1111 from the top opening 1110. The lower tray 1106-b may include handles 1104 for the user to easily carry the egg cooking device 1103-b. Again, the egg cooking tray 1103-b may be constructed from any suitable non-stick food-safe material, such as, for example, silicone or plastic, and may be flexible such that the lower egg-receiving portions 1105 may be pushed upwards to release the cooked egg easily.

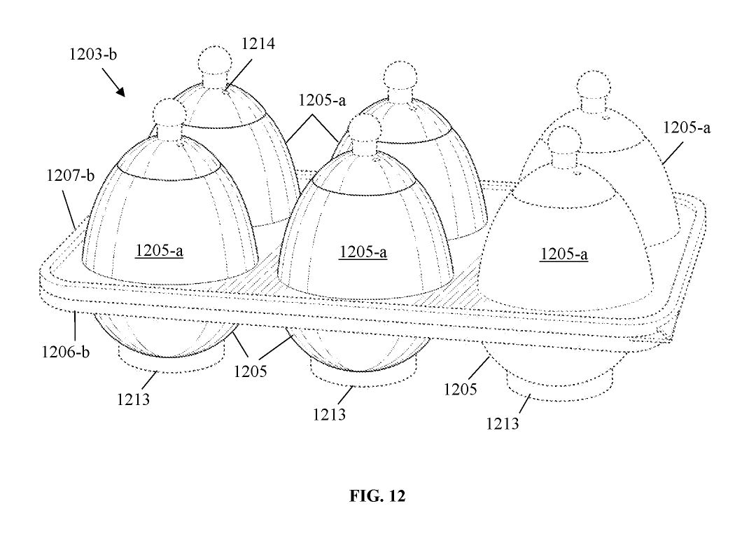

FIG. 12 illustrates the side perspective view of another example of an egg cooking device having a full egg mold (“egg cooking device,” “full mold egg cooking device,” or “egg cooking tray”) 1203-b in a closed state, according to an aspect. The egg cooking device 1203-b may be provided with caps, an upper portion (“upper portion,” “lid,” or “upper tray”), and a lower portion (“lower portion,” or “bottom tray”). Again, the rectangular lower tray 1206-b may be provided having lower egg-receiving portions 1205. A rectangular tray 1106-b may be provided with a flat lid (as shown in FIG. 6) or with a rectangular lid 1207-b having upper egg-receiving portions 1205-a such that a full egg-shaped mold is provided when the lid 1207-b is connected together or combined with the lower portion 1206-b also having lower egg-receiving portions 1205. The lower egg-receiving portions 1205 of the lower portion 1206-b may be provided with a base or foot 1213 such that the full mold egg cooking device may rest evenly on a surface. The egg cooking device 1203-b may also be provided with an air vent 1214 on each egg mold, for example, such that steam created during the cooking process may be released out of the egg cooking device 1203-b.

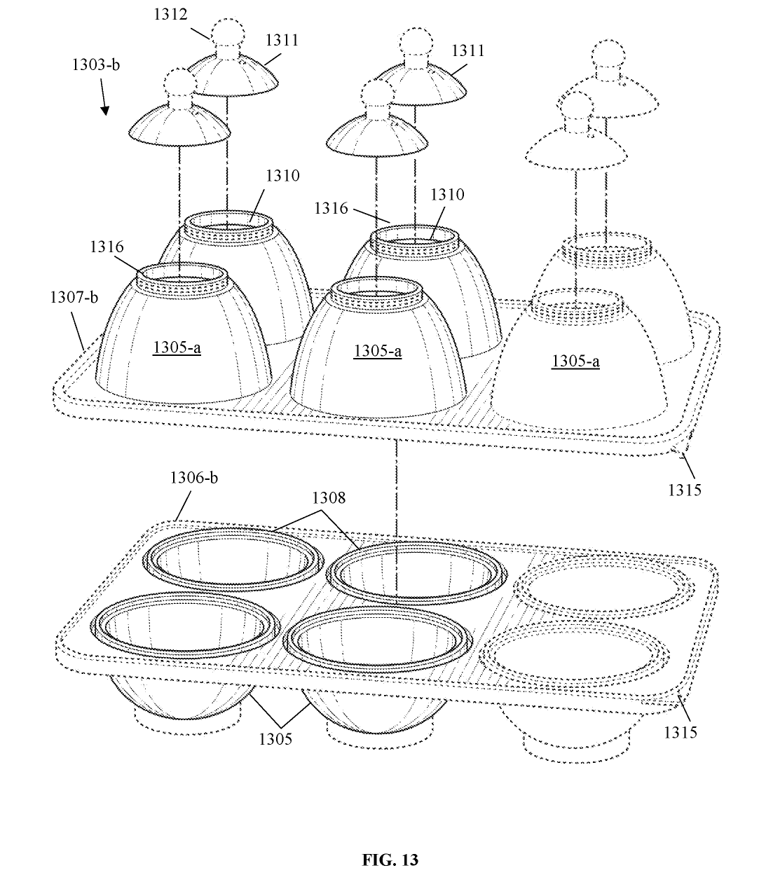

FIG. 13 illustrates the exploded perspective view of the egg cooking device 1303-b of FIG. 12, according to an aspect. An egg cooking device 1303-b may be provided with at least one egg mold, which may be shaped to cook a cracked egg or eggs, or any other similar food, in hot or boiling water or pressure cooker. Each egg mold may be comprised of a plurality of pieces that may be assembled by a user for use. As an example, each egg mold may be comprised of a lower tray portion 1306-b having a bowl 1305 extending downwards from the lower portion 1306-b, combined with an associated or corresponding upper portion 1307-b having an upper bowl 1305-a extending upwards from the upper portion 1307-b. An egg cooking device 1303-b may be provided with one egg mold, or a plurality of egg molds. As shown in FIG. 13 as an example, an egg cooking device 1303-b may be provided with six egg molds. As another example, a lower tray 1306-b may be provided wherein a user may place at least one egg mold or a plurality of egg molds. The lower portion 1306-b and the upper portion 1307-b may each be provided with a flat surface from with the lower bowls 1305 and upper bowls 1305-a extend outwards. The lower portion 1306-b and the upper portion 1307-b may each be provided with pull tabs 1315 which may assist the user in taking apart or separating the lower portion 1306-b the and upper portion 1307-b. The pull tabs 1315 may be provided at a corner of the flat surfaces, for example.

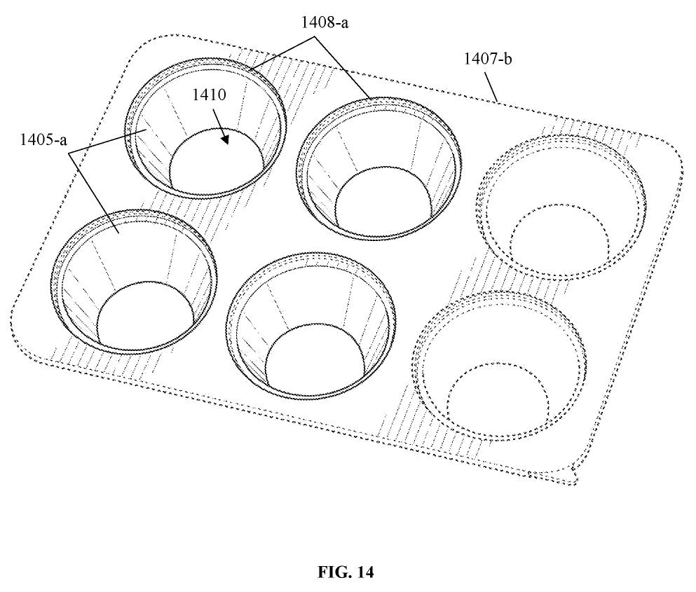

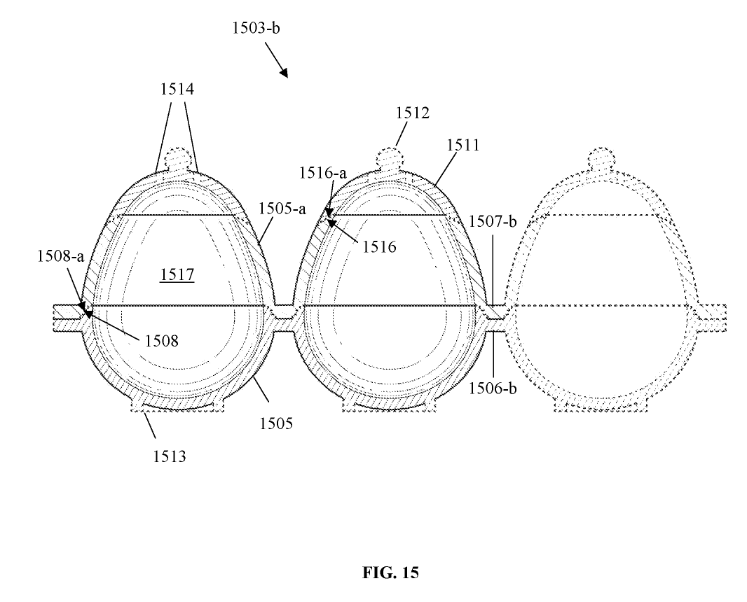

Again, each upper egg-receiving portion 1305-a may be provided with a cap 1311 to cover and seal a top opening 1310 located a top end of each upper bowl 1305-a. The top opening may be an access hole 1310 which may allow a user to pour in eggs or any other suitable food to be cooked in the egg cooking device 1303-b. The access hole 1310 may then be sealed with the cap 1311. The cap 1311 may be provided with a cap handle 1312 which may extend from the cap 1311 to allow a user to easily grasp the cap. The lower bowls 1305 may also include tray rims or ridges 1308 which may fit into or interlock with corresponding tray ridges of the upper bowls 1305-a (as shown by 1408-a in FIG. 14). The upper bowls 1305-a may also be provided with access hole ridges 1316, which may fit into or interlock with corresponding cap ridges (as shown by 1516-a in FIG. 15).

Again, the egg cooking device 1303-b may be constructed from any suitable food-grade or food-safe material that is flexible to allow a user to push the upper or lower egg-receiving portions to force out the cooked food. Both the upper portion 1307-b and the lower portion 1306-b may be constructed of similar flexible and food-safe material.

FIG. 14 illustrates the bottom perspective view of the upper portion 1407-b of the egg cooking device of FIG. 12, according to an aspect. The upper portion 1407-b may be provided with a flat surface having at least one upper bowl 1405-a, which may be joined with a lower bowl (as shown by 1305 in FIG. 13) to create an egg mold. Each upper bowl 1405-a

The lower bowls 1305 may also include rims or ridges 1308 which may fit into corresponding ridges of the upper bowls 1305-a (as shown by 1408-a in FIG. 14).

FIG. 15 illustrates the side sectional elevation view of the egg cooking device 1503-b of FIG. 12 in a closed state, according to an aspect. The lower bowl 1505 and the upper bowl 1505-a of each egg mold may be provided with a set of interlocking ridges, wherein the lower bowl is provided with a plurality of lower tray ridges 1508 and the upper bowl is provided with a plurality of corresponding or matching upper tray ridges 1508-a. When the lower bowl 1505 and the upper bowl 1505-a are associated or connected, the egg mold may thus be formed by the bowls defining a hollow inner space 1517 which may be in the shape of an egg, which may then receive food items and cook the food into the shape defined by the hollow inner space 1517. The upper bowl 1505-a may also be provided with a plurality of top opening ridges 1516 along the rim of the top opening 1510. The cap 1511 may be provided with a plurality of corresponding or matching cap ridges 1516-a.

To cook a cracked or shell-less egg in the egg cooking device 1503-b, the following exemplary process may be carried out. First, a user may assemble the lower portion 1506-b and the upper portion 1307-b of the egg cooking device together by pressing or snapping the upper portion 1307-b onto the lower portion 1506-b until the two portions are interlocked or connected. The association or connection of the upper portion 1307-b with the lower portion 1506-b is achieved by associating the lower tray ridges 1508 with the upper tray ridges 1508-a. During this step, the two portions are aligned such that each one of the lower bowls 1505 in the lower portion 1506-b are matched with an upper bowl 1505-a of the upper portion 1507-b. Next, a cracked egg, egg whites, or any other suitable food is poured into the access hole 1510 of the upper bowl 1505-a. Next, the access hole 1510 having a set of access hole ridges 1516 is sealed, by associating the access hole ridges 1516 associated with the cap ridges 1516-a along the rim of a cap 1511. The assembled egg cooking device is next placed into boiling water, a pressure cooker, or any other suitable means for cooking the food inside of the egg cooking device 1503-b. Next, the food is allowed to cook for a predetermined length of time, such as, for example, approximately 5-10 minutes. Next, the egg cooking device 1503-b is removed from the cooking means such as the boiling water, and the upper portion 1507-b is separated from the lower portion 1506-b, and the cap 1511 may remain associated with the upper portion 1507-b during this step. The cooked food remaining within the lower bowl or bowls 1505 may then be removed from the egg cooking device. The removal step may be achieved by turning the lower portion 1506-b upside down, or by forcing out the food by pressing against a bottom end of the lower bowl 1505.

It should be understood that an egg cooking device in a tray with lid form in any suitable shape may also be provided with tray handles, a flat lid or a lid with upper egg-receiving portions, and cap grips. An egg cooking device may also include a temperature or readiness indicator such that a user may easily tell when the egg is fully cooked. It should also be understood that the egg cooking device in bag or tray form may be leak-proof and waterproof such that submerging the device in boiling water will not introduce water into the portions of the device holding the egg.

It should also be understood that the egg cooking device may be provided in a bag or a tray form having non-stick and food-safe materials, and may be flexible, such that a cooked shell-less egg may be easily removed by pressing the mold of the egg cooking device. It should be understood that the tray having a plurality of whole or partial egg-receiving portions may be provided in any suitable shape.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. An egg cooking device having at least an egg mold, the at least an egg mold comprising:
a lower portion having:
a first flat tray having a first top surface and a first bottom surface;
a lower bowl extending downwards from the first bottom surface, the lower bowl having a first rim located at the first top surface;
a set of lower tray ridges along the first rim;
a flat base associated with the bottom lower bowl end;
an upper portion having:
a second flat tray having a second top surface and a second bottom surface;
an upper bowl extending upwards from the second top surface, the upper bowl having a second rim located at the second bottom surface;
a set of upper tray ridges along the second rim, the set of upper tray ridges being configured to be associated with the set of lower tray ridges;
an access hole at a top end of the upper bowl, the access hole having an access hole rim;
a set of access hole ridges along the access hole rim;
a cap having:
a top cap end;
a bottom cap end having a cap rim;
at least an air vent;
a handle extending upwards from the top cap end;
a set of cap ridges along the cap rim configured to be associated with the set of access hole ridges;
wherein the lower portion is sealed with the upper portion when the set of lower tray ridges is associated with the set of upper tray ridges, and the upper portion is sealed with the cap when the set of access hole ridges is associated with the set of cap ridges; and
wherein the lower portion, the upper portion, and the cap sealed together form the at least an egg mold defining a hollow inner space configured to receive and cook a food item by heating the food item;
such that a cooked food item is created in a shape defined by the hollow inner space.

2. The egg cooking device of claim 1, comprising six egg molds.

3. The egg cooking device of claim 1, wherein the egg cooking device is constructed from flexible non-stick silicone.

4. The egg cooking device of claim 1, wherein the at least an air vent is located at the top end of the cap.

5. The egg cooking device of claim 1, further comprising a first pull tab on a first outer edge of the lower portion and a second pull tab on a second outer edge of the upper portion.

6. An egg cooking device having at least an egg mold, the at least an egg mold comprising:
a lower portion having:
a first flat tray having a first top surface and a first bottom surface;
a lower bowl extending downwards from the first bottom surface, the lower bowl having a first rim located at the first top surface;
a set of lower tray ridges along the first rim; and
an upper portion having:
a second flat tray having a second top surface and a second bottom surface;
a set of upper tray ridges on the second bottom surface, the set of upper tray ridges being configured to be associated with the set of lower tray ridges;
wherein the lower portion is sealed with the upper portion when the set of lower tray ridges is associated with the set of upper tray ridges; and
wherein the lower portion and the upper portion sealed together form the at least an egg mold defining a hollow inner space configured to receive and cook a food item by heating the food item;
such that a cooked food item is created in a shape defined by the hollow inner space.

7. The egg cooking device of claim 6, further comprising an upper bowl extending upwards from the second top surface, the upper bowl having:
a second rim located at the second bottom surface, and wherein the set of upper tray ridges is located along the second rim; and
an access hole at a top end of the upper bowl.

8. The egg cooking device of claim 7, wherein the access hole further comprises an access hole rim and a set of access hole ridges along the access hole rim; the egg cooking device further comprising a cap having:
a top cap end;
a bottom cap end having a cap rim;
at least an air vent;
a handle extending upwards from the top cap end; and
a set of cap ridges along the cap rim configured to be associated with the set of access hole ridges; and
wherein the upper portion is sealed with the cap when the set of access hole ridges is associated with the set of cap ridges.

9. The egg cooking device of claim 6, further comprising a flat base associated with the bottom lower bowl end.

10. The egg cooking device of claim 6, comprising six egg molds.

11. The egg cooking device of claim 6, wherein the egg cooking device is constructed from flexible non-stick silicone.

12. The egg cooking device of claim 6, further comprising a first pull tab on a first outer edge of the lower portion and a second pull tab on a second outer edge of the upper portion.

13. A method of cooking at least a portion of an egg using an egg cooking device having at least an egg mold, the at least an egg mold comprising:
a lower portion having:
a first flat tray having a first top surface and a first bottom surface;
a lower bowl extending downwards from the first bottom surface, the lower bowl having a first rim located at the first top surface;
a set of lower tray ridges along the first rim;
a flat base associated with the bottom lower bowl end;
an upper portion having:
a second flat tray having a second top surface and a second bottom surface;
an upper bowl extending upwards from the second top surface, the upper bowl having a second rim located at the second bottom surface;
a set of upper tray ridges along the second rim, the set of upper tray ridges being configured to be associated with the set of lower tray ridges;
an access hole at a top end of the upper bowl, the access hole having an access hole rim;
a set of access hole ridges along the access hole rim;
a cap having:
a top cap end;
a bottom cap end having a cap rim;
at least an air vent;
a handle extending upwards from the top cap end;
a set of cap ridges along the cap rim configured to be associated with the set of access hole ridges;
wherein the lower portion is sealed with the upper portion when the set of lower tray ridges is associated with the set of upper tray ridges, and the upper portion is sealed with the cap when the set of access hole ridges is associated with the set of cap ridges; and
wherein the lower portion, the upper portion, and the cap sealed together form the at least an egg mold defining a hollow inner space configured to receive and cook the at least the portion of the egg by a heating means, such that a cooked egg item is created in a shape defined by the hollow inner space;
the method comprising the steps of:
providing the lower portion, the upper portion, and the cap of the egg cooking device in a separated state;
aligning the upper bowl with the lower bowl by aligning the set of upper tray ridges with set of lower tray ridges;
applying a force to the upper portion;
sealing the upper portion to the lower portion;
cracking the egg;
pouring at least a portion of the egg into the access hole;
aligning the cap with the access hole by aligning the set of cap ridges with the set of access hole ridges;
applying a force to the cap;
sealing the cap to the access hole of the upper portion;
placing the egg cooking device into a heating means;
leaving the egg cooking device in the heating means for a predetermined amount of time such that the at least a portion of the egg is cooked to create the cooked egg item;
removing the egg cooking device from the heating means;
separating the upper portion from the lower portion; and
removing cooked egg item from the lower portion.

14. The method of claim 13, wherein the heating means is boiling water.

15. The method of claim 13, wherein the egg cooking device further comprises a first pull tab on a first outer edge of the lower portion and a second pull tab on a second outer edge of the upper portion; and wherein the separating step is performed by a user grasping the first pull and the second pull tab to separate the upper portion from the lower portion.

16. The method of claim 13, wherein the egg cooking device comprises six egg molds.

17. The method of claim 13, wherein the removing step is performed by turning the lower portion upside down.

18. The method of claim 13, wherein the egg cooking device is constructed from flexible non-stick silicone.

19. The method of claim 18, wherein the removing step is performed by applying a force to the lower bowl.

20. The method of claim 13, wherein the predetermined amount of time is approximately 5-10 minutes.
